(19) United States
(12) Patent Application Publication
(10) Pub. No.: US 2002/0124539 A1
(43) Pub. Date: Sep. 12, 2002

(54) MECHANISM FOR GOVERNING RPM OF AGRICULTURAL MACHINE'S WORKING MEMBERS

(75) Inventors: Olaf Van der Lely, Zug (NL); Alexander Van der Lely, Rotterdam (NL)

Correspondence Address: Penrose Lucas Albright, Esq.,, MASON, MASON & ALBRIGHT, P. O. Box 2246, Arlington, VA, 22202-0246, US

(73) Assignee: Lely Research Holding AG, a Swiss limited liabilit company

(21) Appl. No.: 09/740,755

(22) Filed: Dec. 20, 2000

Related U.S. Application Data
(63) Continuation of application No. PCT/NL00/00252, filed on Apr. 18, 2000.

(30) Foreign Application Priority Data
Apr. 23, 1999 (NL) 1011885

(51) Int. Cl. G05B 11/32

(52) U.S. Cl. 56/10.2 B; 700/67; 56/10.2 G

(57) ABSTRACT

An agricultural machine having drivable members for working the soil or crop or both. Either the agricultural machine or a tractor connected therewith has a storage medium which may be a computer memory in which a desired relationship between the rpm of the working member and the driving velocity of the agricultural machine is stored. The agricultural machine includes a governor or control mechanism for regulating, on the basis of the relationship stored in the storage medium, the rpm of the working member in dependence on the agricultural machine's velocity. In this manner, the optimum rpm for the driven working member can be set for any driving velocity of the machine to maximize the results obtained by the working member in improved soil or crop conditions or both.

### RELATED APPLICATION

This Application is a continuation of International Application No. PCT/NL00/00252, filed Apr. 18, 2000.

### FIELD OF THE INVENTION

The invention relates to an agricultural machine having a storage medium such as a computer memory which controls the rpm of working members such as rake machines, rotary harrows and mowing machines.

The invention provides an improved agricultural machine that operates at an optimum rpm of the driven working members and at any driving speed which results in an improved working of the soil or crop or both.

### BRIEF DESCRIPTION OF THE DRAWING

The invention will now be explained in further detail with reference to the accompanying drawing, in which:

FIG. 1 is a diagram of a measuring and control system for an agricultural machine according to the invention.

### DETAILED DESCRIPTION OF THE PREFERRED EMBODIMENTS

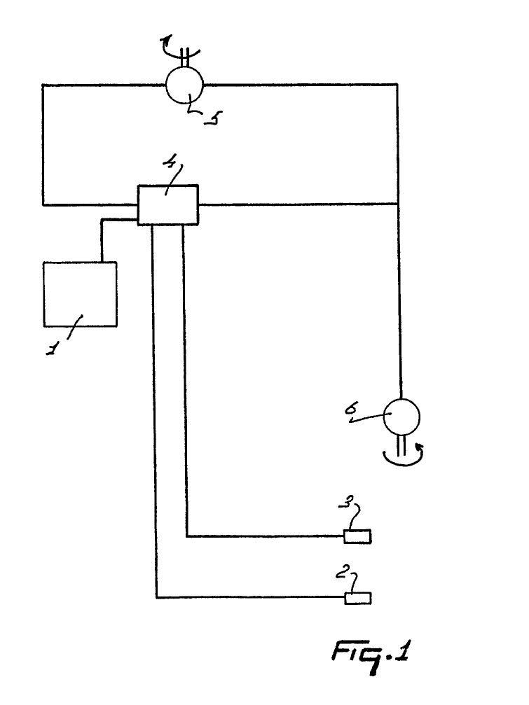

FIG. 1 is a diagram of a measuring and control system for a first embodiment of an agricultural machine according to the invention. The agricultural machine is provided with at least one drivable soil working member or crop working member or both. A storage medium 1 is connected to the agricultural machine, wherein a relationship between the rpm of the working member and the driving speed of the agricultural machine is stored. Storage medium 1 may be constituted by a computer memory. Storage medium 1 is not necessarily directly fastened to the agricultural machine, but may also be provided elsewhere such as being mounted on the tractor of the agricultural machine. It is, however, connected directly or indirectly (in a wireless manner) to the agricultural machine.

The relationship stored may consist of a series of values for the driving speed and a corresponding series of values for the rpm. The relationship may also comprise a functional relationship which associates each value of the driving speed in a certain interval with a corresponding value for the rpm of the working member. Preferably, the stored relationship links an optimum value for the rpm to each value for the driving speed. These optimum values may be predetermined, for example, by the manufacturer, or by means of tests with the agricultural machine. The agricultural machine is provided with means for regulating, on the basis of relationships stored in storage medium 1, the rpm of the working member in dependence of the current driving speed of the agricultural machine, so that the rpm is always set automatically in an optimum manner.

In a preferred embodiment, for various values of at least one working parameter, there is stored for each a corresponding relationship between the rpm and the driving speed. The working parameters may comprise the type of soil or the type of crop or the amount of crop or the humidity of the crop or any combination thereof. The working parameters are each adjustable, whereby the corresponding relation can be selected. For each value of a working parameter there is stored in storage medium 1 a relationship between the driving speed and the rpm, on the basis of which the rpm of the working member is regulated.

Each working parameter may be manually adjustable by a user. When the humidity of a crop to be raked is adjustable as a working parameter, the user can choose, with the aid of a selector button on storage medium 1 a value which may be from 1 to 5, the value 1 corresponding to dry crop and the value 5 to very wet crop. It is also possible that the agricultural machine is provided with measuring means for measuring a quantity which is relevant to at least one working parameter, said measuring means being suitable for automatically adjusting the relevant working parameter or parameters. For a quantity to be measured such as the conductivity, density or resistance of the type of soil or the crop, the measuring means may comprise a conductivity sensor, a measuring pin for measuring soil density or a measuring device with an angular deflection for measuring the amount of crop. In this manner the working parameters can be adjusted automatically, as a result of which the correct relationships in storage medium 1 are selected automatically, by means of which the rpm of the working member is regulated automatically.

The working member may comprise a rotary harrow, a crushing rotor of a mowing machine, a mowing disc of a mowing machine, a rake device or a tedder member of a tedder. A preferred embodiment, described hereinafter, is a rake machine wherein, according to the invention, the rpm of the rake members is regulated in dependence of the driving speed of the agricultural machine.

A sensor 2 for measuring the current driving speed of the agricultural machine may be provided on the agricultural machine itself, on the tractor or elsewhere. The agricultural machine is further provided with a sensor 3 for measuring the current rpm of the working member. Storage medium 1 and sensors 2 and 3 are connected, directly or indirectly (in a wireless manner), to a control valve 4. A hydraulic pump 5 is provided which is driven via a power take-off shaft of the tractor or other means. Finally a hydraulic motor 6 which is suitable for driving the rake member is provided.

Hydraulic motor 6 is actuated by hydraulic pump 5, while control valve 4 returns part of the oil, flowing from hydraulic pump 5 to hydraulic motor 6, back to hydraulic pump 5. By regulating exactly, by means of control valve 4, the proportion between the amount of oil flowing to the hydraulic motor and the amount of oil flowing back to hydraulic pump 5, as governed by signals from sensors 2 and 3 and the relationships stored in storage medium 1, the rpm of the rake member can be accurately regulated.

In an embodiment of the invention, there are provided signal means, which are connected to the agricultural machine, for giving a warning signal when the driving speed of the agricultural machine increases or decreases beyond permitted speed bounds. In this manner the user is warned when he is driving too fast or too slowly.

In a further embodiment, the working member can be controlled by means of a curved path, the position of the curved path being adjustable in dependence of a pertinent working parameter or parameters. In this manner a further optimization of the crop working can be achieved.

Of course, there are other ways of regulating the rpm in accordance with the desired relationships stored in storage medium 1, such as by means of variable speed gears known per se.

Although we have disclosed the preferred embodiments of our invention, it is to be understood that it is capable of other adaptations and modifications within the scope of the following claims:

Having disclosed our invention, what we claim as new and to be secured by Letters Patent of the United States of America is:

1 (Amended). An agricultural machine [provided with] which comprises at least one drivable [soil and/or crop] working member, [characterized in that there is provided] a storage medium [(1),] connected to the agricultural machine, in which storage medium a relationship between the rpm of the working member and the driving speed of the agricultural machine is stored, and [the agricultural machine is provided with] governing means [(2 -6)] for regulating, on the basis of the relationship stored, the rpm of the working member in dependence of the current driving speed of the agricultural machine.

2 (Amended). An agricultural machine [as claimed] in accordance with claim 1, [characterized in that for various] whereas a value[s] of at least one working parameter [there] is stored [each time] in said storage medium for which a corresponding relationship between the rpm and the driving speed is also stored.

3 (Amended). An agricultural machine [as claimed] in accordance with claim 2, [characterized in that the] wherein said working parameter[(s)] is[/are] adjustable, as a result of which the corresponding relation[(s)] ship is[/are] selectable.

4 (Amended). An agricultural machine [as claimed] in accordance with claim 3, [characterized in that the] wherein said working parameter[(s)] is[/are] manually adjustable by a user.

20. An agricultural machine in accordance with claim 3, which further comprises measuring means for performing the function of measuring a quantity of said at least one working parameter, said measuring means being adaptable to adjust said at least one working parameter.

21. An agricultural machine in accordance with claim 2, wherein said working parameter consists of at least one of the following parameters: the type of soil, the type of crop, the amount of crop, and the humidity of the crop.

22. An agricultural machine in accordance with claim 1, wherein said working member is ground-drivable.

23. An agricultural machine in accordance with claim 1, wherein said governing means comprises a hydraulic motor.

24. An agricultural machine in accordance with claim 1, wherein said governing means comprises an electric motor.

25. An agricultural machine in accordance with claim 1, which further comprises a sensor for measuring the velocity of the agricultural machine.

26. An agricultural machine in accordance with claim 1, further comprising a sensor for measuring the rpm of said working member.

27. An agricultural machine as claimed in claim 1, which further comprises a velocity sensor and an rpm sensor, a control valve being provided which interconnects said storage medium, said velocity sensor and said rpm sensor.

28. An agricultural machine in accordance with claim 1, which further comprises alarm means for warning the operator when the driving speed of agricultural machine is not within a predetermined velocity range.

29. An agricultural machine in accordance with claim 1, comprising a curved path for controlling said working member, the position of the curved path being adjustable by a working parameter therefor.

30. An agricultural machine in accordance with claim 1, wherein said working member comprises a rotary harrow.

31. An agricultural machine in accordance with claim 1, wherein said working member comprises a crushing rotor.

32. An agricultural machine in accordance with claim 1, wherein said working member comprises a mowing disc.

33. An agricultural machine in accordance with claim 1, wherein said working member comprises a raking member.

34. An agricultural machine in accordance with claim 1, wherein said working member comprises a tedding member.

35. An agricultural machine in accordance with claim 1, wherein said storage medium comprises a computer memory.
